(19) United States
(12) Patent Application Publication
(10) Pub. No.: US 2013/0007139 A1
(43) Pub. Date: Jan. 3, 2013

(54) LOGICAL THREAD MANAGEMENT THROUGH EMAIL INFRASTRUCTURE

(75) Inventors: VINICIO BOMBACINO, ROME (IT); CLAUDIO FALCONE, ROME (IT); LEONARDO LANNI, ROME (IT); ANDREA TORTOSA, ROMA (IT)

(73) Assignee: INTERNATIONAL BUSINESS MACHINES CORPORATION, ARMONK, NY (US)

(21) Appl. No.: 13/172,176

(22) Filed: Jun. 29, 2011

(51) Int. Cl. G06F 15/16

(52) U.S. Cl. 709/206

(57) ABSTRACT

A method that includes, via a processor, receiving at least one user input within an electronic mail (email) client associating a first email with a logical thread. The first email can specify a task assigned to at least one recipient of the first email. The method further can include sending the first email to the at least one recipient, adding the first email to a logical thread list associated with the logical thread, and receiving a task response from the recipient. Within the logical thread list, a task status associated with the first email based upon the task response can be automatically updated.

### BACKGROUND

One or more embodiments disclosed within this specification relate to logical thread management. More particularly, one or more embodiments relate to logical thread management through electronic mail (email) infrastructure.

Oftentimes entails correspond or belong to logical threads. In this regard, logical thread is a group of events that are related to a common subject. In illustration, a logical thread may include specific tasks to be accomplished, answers to specific questions, probable information aggregation, and so on. The tasks in a particular logical thread may be assigned to one person, or many people. Generally, it is important for project managers to maintain awareness of the tasks associated with a logical thread.

### BRIEF SUMMARY

One or more embodiments disclosed within this specification relate to logical thread management and, more particularly, to logical thread management through email infrastructure.

An embodiment can include a method that includes, via a processor, receiving at least one user input within an electronic mail (email) client associating a first email with a logical thread. The first email can specify a task assigned to at least one recipient of the first email. The method further can include sending the first email to the at least one recipient, adding the first email to a logical thread list associated with the logical thread, and receiving a task response from the recipient. Within the logical thread list, a task status associated with the first email based upon the task response can be automatically updated,

Another embodiment can include, via a processor, receiving an email associated with a logical thread. The email can specify a task assigned to a recipient of the email. The method further can include identifying the task, adding the task to a task list associated with the recipient of the email, receiving a user input from the recipient indicating a task response, and sending the task response to a sender of the email.

Another embodiment can include a computer program product for logical thread management. The computer program can include a computer-readable storage medium having computer-readable program code embodied therewith. The computer-readable program code can be configured to perform the various steps and/or functions disclosed within this specification.

### BRIEF DESCRIPTION OF THE SEVERAL VIEWS OF THE DRAWINGS

FIG. 1 is a block diagram illustrating a system for managing logical threads in accordance with one embodiment of the present invention.

FIG. 2 depicts a logical thread list in accordance with one embodiment of the present invention.

FIG. 3 depicts a view within an email client for composing an email in accordance with one embodiment of the present invention.

FIG. 4 is a flow chart illustrating a method of managing logical threads in accordance with one embodiment of the present invention.

FIG. 5 is a flow chart illustrating a method of managing logical threads in accordance with another embodiment of the present invention.

FIG. 6 is a block diagram of an email client system in accordance with another embodiment of the present invention.

### DETAILED DESCRIPTION

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer-readable medium(s) having computer-readable program code embodied, e.g., stored, thereon.

Any combination of one or more computer-readable medium(s) may be utilized. The computer-readable medium may be a computer-readable signal medium or a computer-readable storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present invention may be written in any combination of one or more programming languages, including an object oriented programming language such as Java™, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area. network (WAN), or the connection may be made to an external computer (for example, through the Internet using an Internet Service Provider).

Aspects of the present invention are described below with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer, other programmable data processing apparatus, or other devices create means for implementing the functions/acts specified in the flowchart and/or block diagram block or blocks.

These computer program instructions may also be stored in a computer-readable medium that can direct a computer, other programmable data processing apparatus, or other devices to function in a particular manner, such that the instructions stored in the computer-readable medium produce an article of manufacture including instructions which implement the function/act specified in the flowchart and/or block diagram block or blocks.

The computer program instructions may also be loaded onto a computer, other programmable data processing apparatus, or other devices to nausea series of operational steps to be performed on the computer, other programmable apparatus or other devices to produce a computer implemented process such that the instructions which execute on the computer or other programmable apparatus provide processes for implementing the functions/acts specified in the flowchart and/or block diagram Hock or blocks.

The present invention relates to logical thread management through email infrastructure. Specifically, a logical thread can be originated by a user using an electronic mail (email) client. For example, the user can generate an email and identify the email as pertaining to a logical thread. For example, one Or more attributes can be set to identify the logical thread. Further, the user can assign a task to one or more recipients identified in a “To” field of the email. In illustration, an attribute in an email can be set to indicate that the email relates to a task and/or identify the task that is to be completed. The tasks can include status checks, work or research to be performed, questions to be answered, and the like.

When the email is sent, the email can be queued in a logical thread list and can indicate the task that is to be completed. If the email is sent to a plurality of recipients, a plurality of instances of the task can be created and associated with the email in the logical thread list. Each of the instances of the task can be assigned to a respective recipient of the email. For each task instance, the logical thread can indicate when status updates for the tasks should be received, when the tasks should be completed, and/or whether the tasks have been completed.

When the email is received by a recipient's email client, the task can be added to the recipient's task list. For example, the task can be added to the recipient's calendar. When the user marks the task as being completed, responds to the email with an indication that the task has been completed, or provides some other indication of the status of the task, the status can be communicated to the sender's email client to update a corresponding task status that is associated with the original email in the logical thread list.

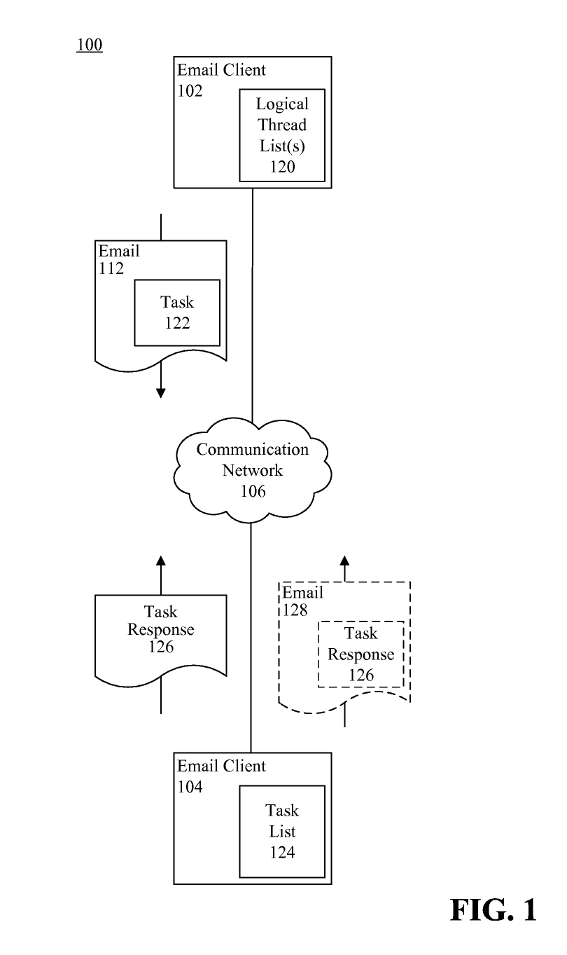

FIG. 1 is a block diagram illustrating a system 100 for managing logical threads in accordance with one embodiment of the present invention. The system 100 can include an email client 102 associated with a user that generates an email 112. The system 100 also can include an email client 104 that receives the email 112. The email clients 102, 104 can be communicatively linked via a communication network 106. The communication network 106 can comprise the Internet, a wide area network (WAN), a local area network (LAN), and/or any other networks via which emails can be communicated.

When the email 112 is generated, the user composing the email 112 can identify the email 112 as originating a logical thread. In this regard, the user can choose to originate a new logical thread based on the email 112. In illustration, the user can set an attribute for the email 112, such as a flag, which specifies that the email 112 corresponds to a logical thread, for example by selecting a check box, button, icon, or the like within an email creation view presented in the user interface of the email client 102. When a user chooses to create a new logical thread, the user also can set an attribute to provide a logical thread identifier for the logical thread. The attributes can be set in a header, body or footer of the email 112, or set in another suitable manner. When a new logical thread is created, a logical thread list 120 can be generated by the email client 102 for that logical thread. Accordingly, each of the user's logical threads can have an associated logical thread list 120.

In another embodiment, the user can assign the email 112 to an existing logical thread. When the user chooses to associate the email 112 with an existing logical thread, the user can set the attribute, such as a flag, to associate the email 112 with a logical thread. Further, the user can set a logical thread identifier attribute to identify the logical thread with which the email 112 is to be associated. For instance, a list of the user's logical threads can be presented when the attribute is selected, and the user can select a logical thread from the list. The list can be presented in any suitable manner, for example via a combo box.

The email 112 can identify a task 122 assigned to one or more recipients. The task 122 can be identified in the header, body or footer of the email, or identified in any other suitable manner. In one embodiment, a task attribute, such as a flag or metadata, associated with the email 112 can indicate that a task is associated with the email. When the email 112 is sent, the email 112 can be added to the logical thread list 120 for the logical thread with which the email 112 is associated. In one embodiment, if there are multiple of recipients identified in the email 112, for example in a “To” field, an instance of the task assigned by the email 112 can be added to the logical thread list 120 for each of the recipients. In illustration, if there are four recipients of the email 112, four instances of the task can be added to the logical thread list 120.

A status indicator can be associated with each logical thread list 120. Moreover, a status indicator can be associated with each email 112 and/or each instance of the email 112 contained in the logical thread list 120. The status indicators will be discussed herein in further detail.

When the email client 104 receives the email 112, or when the recipient opens the email 112, the email client can identify a task attribute, such as a flag or metadata, associated with the email 112 that indicates the email specifies a task 122. In response, the email client 104 can identify the task 122 from the email. For example, the email client 104 can identify the task 122 from a subject line of the email 112 or a custom email field. In one embodiment, the email client 104 can perform semantic analysis on content of the email 112 using applicable semantic rules to identify the status of the task 122. Semantic analysis is known to those skilled in the art. The semantic rules can be standardized rules, or rules that are customized. For example, the semantic rules can be specified by the originator of the logical thread (e.g., the email sender). The semantic rules can be stored locally on the email client 104, or accessed from another location. For example, the semantic rules can be accessed from an email server. In another arrangement, the semantic rules can be provided as an attachment to the email 112. The semantic rules can be parsed from the email by the email client 104 to perform the semantic analysis.

When the task 122 is identified, the task 122 can be added to the recipient's task list 124. For example, the task 122 can be added to an electronic calendar associated with the recipient. If the email 112 specifies a time and/or date when the task 122 is to be completed, the task 122 can be associated with the appropriate time and/or date. Further, reminders can be added to the calendar. The reminders can be automatically generated based on the recipient's user preferences, or based on the sender's preferences, which may be specified by metadata associated with the task 122.

In one embodiment, when the email 112 is opened by the recipient, the recipient can be provided options for responding to the email 112. For example, within the email client 102, a menu, such as a combo box or other suitable user interface object, can be presented from which the recipient can choose a standard response, or enter a custom response. In this regard, the menu can be custom menu presented within a view of the opened email 112, for example within a header of the email 112.

In one embodiment, when the recipient enters a response, a task response 126 can be communicated from the email client 104 to the email client 102, for example as a message. Such message need not be an email. In another embodiment, the task response 126 can be sent in an email 128 generated in reply to the email 112. The task response 126 can identify the email 112, the logical thread with which the email 112 is associated, and/or the task 122. When the email client 102 receives the email 128, or when the email 128 is opened by the recipient, the email client 102 can perform semantic analysis on content of the email 128 to identify the task response 126. Further, the email 128 can identify the email 112 and/or the logical thread list 120 with which the email 112 is associated.

Regardless of how the task response 126 is communicated to the email client 102, the email client 102 can update the logical thread list when the task response 126 is identified by the email client 102. In illustration, the status indicator for the email 112 within the logical thread list 120 can be updated in accordance with the task response 126. For example, if the task response 126 indicates that the task is complete, the status indicator for the email 112 can be updated to indicate “complete”.

Further, the email client 102 can update the status of the logical thread list 120. For example, if there are eight emails in the logical thread lists 120, and four of those emails indicate tasks which have not yet been completed, the status indicator for the logical thread list 120 can indicate a fifty percent status. In one arrangement, the status indicator can be presented as a graphic comprising a bar representing the percentage of completed tasks. In another arrangement, the status indicator can be presented as a graphic that presents a particular color corresponding to the percentage of tasks that have been completed. When all tasks associated with emails contained in the logical thread list 120 have been completed, or there are no tasks (or task instances) associated with the emails pending, the logical thread list 120 can be automatically removed from the email client 120 or archived, though this need not be the case.

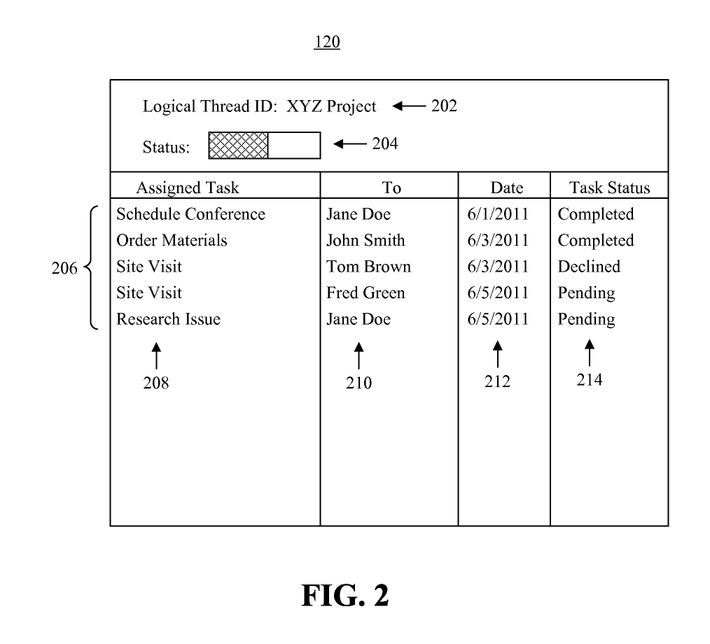

FIG. 2 depicts a logical thread list 120 in accordance with one embodiment of the present invention. The logical thread list 120 can be managed by an email client, and can be presented in a view of the email client when selected. The logical thread list 120 can include a logical thread identifier 20 that uniquely identifies, within the email client, the logical thread represented by the logical thread list 120. The logical thread list 120 also can include a status indicator 204 that indicates a present status of the logical thread. In one arrangement, tasks that are declined can be excluded from the percentage determination, but this need not be the case.

The logical thread list 120 further can include one or more tasks 206 assigned by an email associated with the logical thread. For each task 206, the logical thread list 120 can indicate an identifier 208 for the assigned task 206. The identifier 208 can be indicated by a task field of the email, a subject field, or the like. For each task 206, the logical thread list 120 further can indicate the person 210 to whom the task 206 is assigned (e.g., to whom the email was sent), and the date 212 the task 206 was assigned (e.g., when the email was sent). The logical thread list 120 also can present a status indicator 214 for each of the tasks. The entails corresponding to the tasks 206 can be opened, when desired, by selecting the tasks 206 from the logical thread list 120 in a suitable manner, for example using a cursor.

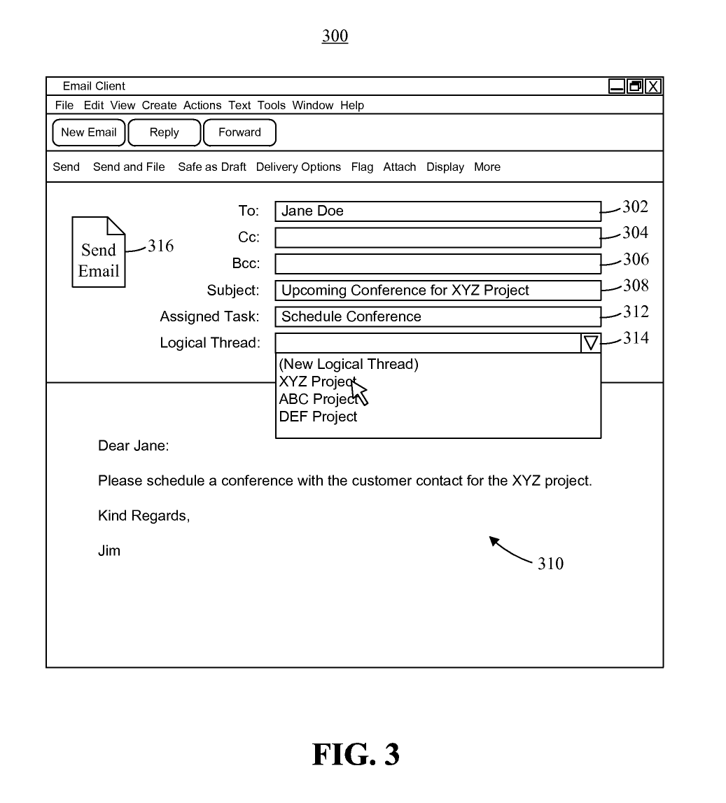

FIG. 3 depicts a view 300 within an email client for composing an email in accordance with one embodiment of the present invention. The view 300 can include a plurality of fields for receiving user inputs relating to composing an email, replying to an email, forwarding an email, etc. For example, the view can include a “To:” filed 302, a “Cc:” field 304, a “Bcc:” filed 306, a “Subject” field 308 and a body 310. In addition, the view 300 further can include an “Assigned Task” field 312 and a “Logical Thread” field 314. In one arrangement, the field 312 can be a combo box, though this need not be the case.

A task assigned by the email can be indicated by the “Assigned Task” field 312 of the view 300. In an embodiment in which the “Assigned Task” field 312 is not present in the view 300, the task assigned by the email can be indicated by the “Subject” field 308 of the view 300, or indicated in any other suitable manner.

Via the field 314, a user can select a logical thread with which the email being generated in the view 300 is to be associated. For example, the user can choose a drop down menu for the field 314, and the drop down menu can present various logical threads from which the user can choose. In addition, the user can choose to create anew logical thread. If the user chooses to create a new logical thread, a pop up window (not shown) can be presented to the user to receive user inputs to setup the logical thread. Alternatively, the user can enter a new logical thread name into the field 314.

When composition of the email is complete, the user can select a suitable control, such as a “Send Email” control 316, to send the email to the recipient.

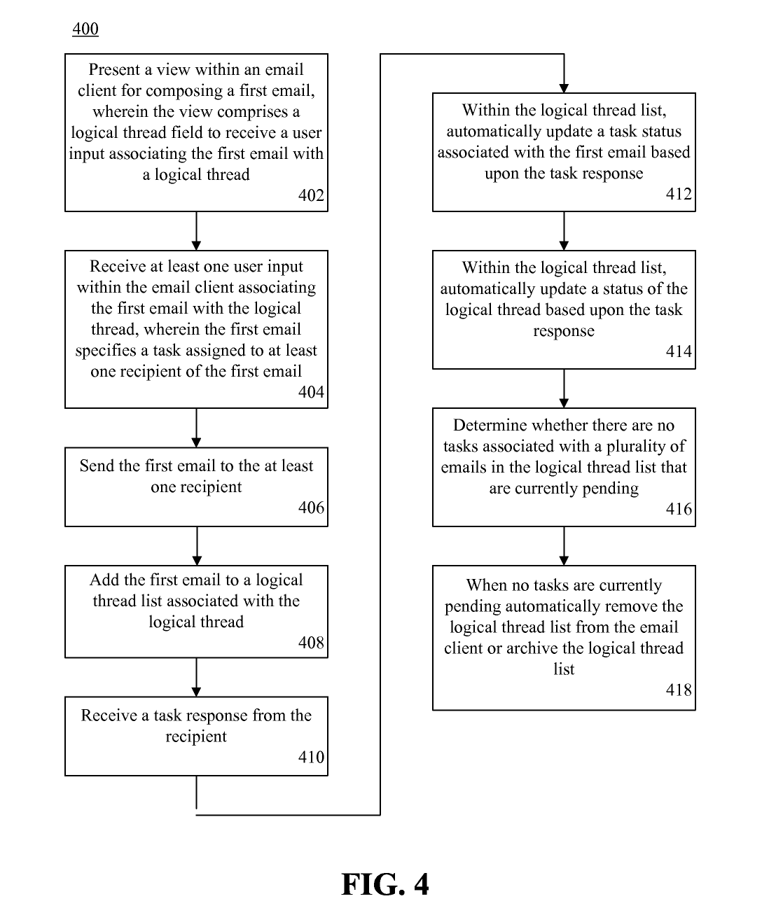

FIG. 4 is a flow chart illustrating a method 400 of managing logical threads in accordance with one embodiment of the present invention. At step 402, a view for composing a first email can be presented within an email client. The view can comprise a logical thread field to receive a user input associating the first email with a logical thread. At step 404, at least one user input can be received within the email client associating the first email with the logical thread. The first email can specify a task assigned to at least one recipient of the first email.

At step 406, the first email can be sent to at least one recipient. At step 408, the first email can be added to a logical thread list associated with the logical thread. If there is more than one recipient, each of whom received the email, a task instance can be associated with the email for each of the recipients. Further, the logical thread list can comprise other mails associated with the logical thread that previously were sent. Additional emails associated with the logical thread also can be added to the logical thread list.

At step 410, a task response can be received from the recipient. If there is more than one recipient, a task response can be received from each of the recipients. For example, a second email can be received from the recipient, and the task response can be identified within the second email. In one embodiment, a semantic analysis can be performed on content of the second email.

At step 412, within the logical thread list, a task status associated with the first email can be automatically updated based upon the task response. If there are multiple instances of the task, for example the email assigning the task was sent to a plurality of recipients, the task status of each instance of the task associated with the recipient from whom the task response is received can be updated based on the task response. At step 414, within the logical thread list, a status of the logical thread can be automatically updated based upon the task response.

At step 416, a determination can be made as to whether there are no tasks associated with the logical thread list that are currently pending. If not, at step 418, the logical thread list can be automatically removed from the email client or archived.

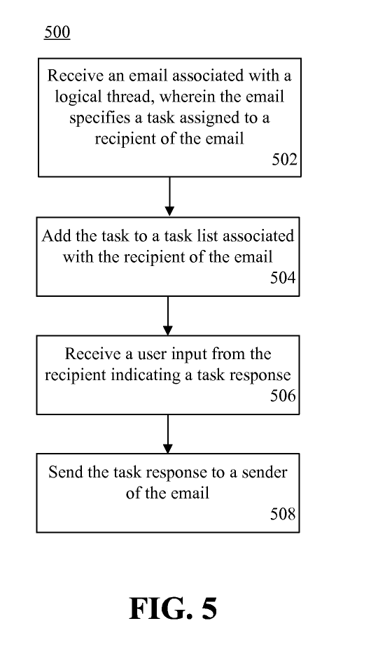

FIG. 5 is a flow chart illustrating a method 500 of managing logical threads in accordance with another embodiment of the present invention. At step 502, an email associated with a logical thread can be received. The email can specify a task assigned to a recipient of the email. At step 504, the task can be added to a task list associated with a recipient of the email. At step 506, a user input can be received from the recipient indicating a task response. At step 508, the task response can be sent to a sender of the email.

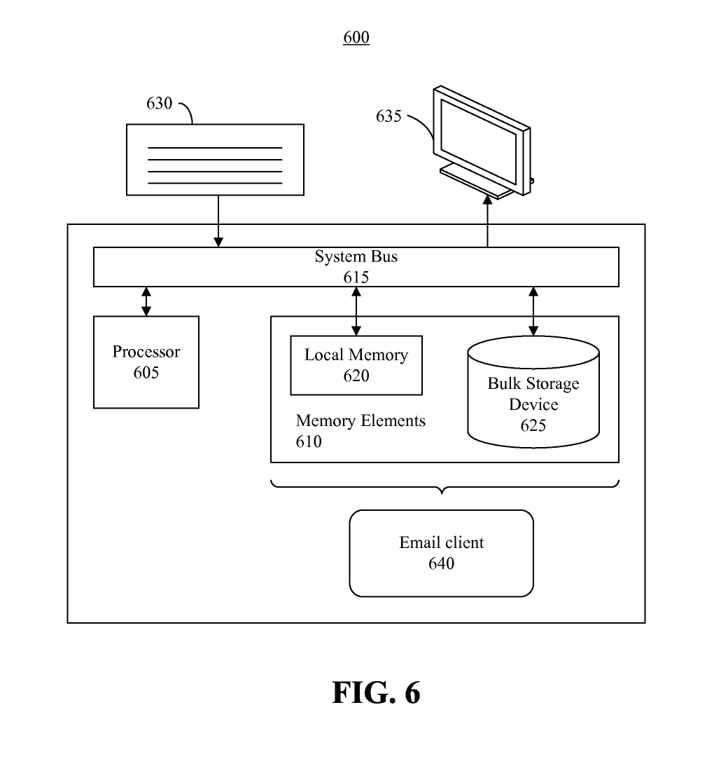

FIG. 6 is a block diagram of an email client system (hereinafter “system”) 600 in accordance with another embodiment of the present invention. The system 600 can include at least one processor 605 coupled to memory elements 610 through a system bus 615. As such, the system 600 can store program code within the memory elements 610. The processor 605 can execute the program code accessed from the memory elements 610 via the system bus 615. In one aspect, for example, the system 600 can be implemented as computer that is suitable for storing and/or executing program code. It should be appreciated, however, that the system 600 can be implemented in the form of any system comprising a processor and memory that is capable of performing the functions described within this specification.

The memory elements 610 can include one or more physical memory devices such as, for example, local memory 620 and one or more bulk storage devices 625. Local memory 620 refers to random access memory or other non-persistent memory device(s) generally used during actual execution of the program code. Bulk storage device(s) 625 can be implemented as a hard disk drive (HDD), solid state drive (SSD) or other persistent data storage device. The system 600 also can include one or more cache memories (not shown) that provide temporary storage of at least some program code in order to reduce the number of times program code must be retrieved from bulk storage device 625 during execution.

Input/output (I/O) devices such as a keyboard 630, a display 635, and a pointing device (not shown) optionally can be coupled to the system 600. The devices can be coupled to the system 600 either directly or through intervening I/O controllers. Network adapters also can be coupled to the system 600 to enable the system 600 to become coupled to other systems, computer systems, remote printers, and/or remote storage devices through intervening private or public networks. Modems, cable modems, and Ethernet cards are examples of different types of network adapters that can be used with the system 600.

As pictured in FIG. 1, the memory elements 610 can store an email client 640, the email client 640 being implemented in the form of executable program code, can be executed by the system 600. The email client 640 can implement the processes and functions described herein for performing logical thread management through email infrastructure.

Like numbers have been used to refer to the same items throughout this specification. In one embodiment, the email client 640 can be implemented as IBM® Lotus Notes® (IBM and Lotus Notes are trademarks of International Business Machines Corporation in the United States, other countries, or both).

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

1. A method of logical thread management, the method comprising:
via a processor, receiving at least one user input within an electronic mail (email) client associating a first email with a logical thread, wherein the first email specifies a task assigned to at least one recipient of the first email;
sending the first email to the at least one recipient;
adding the first email to a logical thread list associated with the logical thread;
receiving a task response from the recipient; and
within the logical thread list, automatically updating a task status associated with the first email based upon the task response.

2. The method of claim 1, further comprising:
automatically updating a status of the logical thread based upon the task response.

3. The method of claim 1, wherein receiving the task response from the client comprises:
receiving a second email from the recipient; and
identifying the task response in the second email.

4. The method of claim 3, wherein identifying the task response in the second email comprises performing a semantic analysis on content of the second email.

5. The method of claim 4, further comprising:
receiving semantic rules from a server;
wherein performing the semantic analysis on content of the second email comprises performing the semantic analysis using the semantic rules received from the server.

6. The method of claim 4, further comprising:
accessing locally stored semantic rules;
wherein performing the semantic analysis on content of the second email comprises performing the semantic analysis using the locally stored semantic rules.

7. The method of claim 1, further comprising:
presenting a view within the email client for composing the first email, wherein the view comprises a logical thread field to receive a user input associating the first email with the logical thread.

8. The method of claim 1, further comprising:
presenting a view within the email client for composing the first email, wherein the view comprises an assigned task field to receive a user input indicating the task assigned to the recipient of the first email.

9. The method of claim 1, wherein:
sending the first email to the at least one recipient comprises sending the first email to each of a plurality of recipients;
adding the first email to a logical thread list comprises, for each recipient, adding to the logical thread list a respective task instance corresponding to the first email; and
automatically updating the task status associated with the first email comprises updating the task status for the task instance associated with the recipient from whom the task response is received.

10. The method of claim 1, wherein the logical thread list comprises a plurality of tasks instances, further comprising:
determining that there are not any task instances in the logical thread list that are currently pending; and
automatically removing the logical thread list from the email client or archiving the logical thread list.

11. A method of logical thread management, the method comprising:
via a processor, receiving a first email associated with a logical thread, wherein the email specifies a task assigned to a recipient of the first email;
identifying the task;
adding the task to a task list associated with the recipient of the first entail;
receiving a user input from the recipient indicating a task response; and
sending the task response to a sender of the first email.

12. The method of claim 11, wherein sending the task response comprises:
sending a second email to the sender of the first email, the second email indicating the logical thread.

13. A computer program product for logical thread management, the computer program product comprising:
a computer-readable storage medium having computer-readable program code embodied therewith, the computer-readable program code comprising:
computer-readable program code configured to send the first email to the at least one recipient;
computer-readable program code configured to add the first email to a logical thread list associated with the logical thread;
computer-readable program code configured to receive a task response from the recipient; and
computer-readable program code configured to, within the logical thread list, automatically update a task status associated with the first email based upon the task response.

14. The computer program product of claim 13, further comprising:
computer-readable program code configured to automatically update a status of the logical thread based upon the task response.

15. The computer program product of claim 13, wherein the computer-readable program code configured to receive the task ‘response from the client comprises:
computer-readable program code configured to receive a second email from the recipient; and
computer-readable program code configured to identify the task response in the second email.

16. The computer program product of claim 15, wherein the computer-readable program code configured to identify the task response in the second email comprises computer-readable program code configured to perform a semantic analysis on content of the second email.

17. The computer program product of claim 16, further comprising:
computer-readable program code configured to receive semantic rules from a server;
wherein the computer-readable program code configured to perform the semantic analysis on content of the second email comprises computer-readable program code configured to perform the semantic analysis using the semantic rules received from the server.

18. The computer program product of claim 16, further comprising:
computer-readable program code configured to access locally stored semantic rules;
wherein the computer-readable program code configured to perform the semantic analysis on content of the second email comprises computer-readable program code configured to perform the semantic analysis using the locally stored semantic rules.

19. The computer program product of claim 13, further comprising:
computer-readable program code configured to present a view within the email client for composing the first email, wherein the view comprises a logical thread field to receive a user input associating the first email with the logical thread.

20. The computer program product of claim 13, further comprising:
computer-readable program code configured to present a view within the email client for composing the first email, wherein the view comprises an assigned task field to receive a user input indicating the task assigned to the recipient of the first email.

21. The computer program product of claim 13, wherein:
the computer-readable program code configured to send the first email to the at least one recipient comprises computer-readable program code configured to send the first email to each of a plurality of recipients;
the computer-readable program code configured to add the first email to a logical thread list comprises computer-readable program code configured to, for each recipient, add to the logical thread list a respective task instance corresponding to the first email; and
the computer-readable program code configured to automatically update the task status associated with the first email comprises computer-readable program code configured to update the task status for the task instance associated with the recipient from whom the task response is received.

22. The computer program product of claim 13, wherein the logical thread list comprises a plurality of task instances, further comprising:
computer-readable program code configured to determine that there are not any task instances in the logical thread list that are currently pending; and
computer-readable program code configured to automatically remove the logical thread list from the email client or archiving the logical thread list.

23. A computer program product for logical thread management, e computer program product comprising:
a computer-readable storage medium having computer-readable program code embodied therewith, the computer-readable program code comprising:
computer-readable program code configured to receive an email associated with a logical thread, wherein the email specifies a task assigned to a recipient of the email;
computer-readable program code configured to identify the task;
computer-readable program code configured to add the task to a task list associated with the recipient of the email;
computer-readable program code configured to receive a user input from the recipient indicating a task response; and
computer-readable program code configured to send the task response to a sender of the email.

24. The computer program product of claim 23, wherein the computer-readable program code configured to send the task response comprises:
computer-readable program code configured to send a second email to e sender of the first email, the second email indicating the logical thread.
